(19) United States
(12) Patent Application Publication
(10) Pub. No.: US 2021/0397848 A1
(43) Pub. Date: Dec. 23, 2021

(54) SCENE MARKING

(71) Applicant: Scenera, Inc., Palo Alto, CA (US)

(72) Inventors: David D. Lee, Palo Alto, CA (US); Andrew Augustine Wajs, Haarlem (NL); Seungoh Ryu, Newton, MA (US); Chien Lim, San Jose, CA (US)

(21) Appl. No.: 17/464,615

(22) Filed: Sep. 1, 2021

Related U.S. Application Data
(63) Continuation of application No. 15/487,416, filed on Apr. 13, 2017, now abandoned.
(60) Provisional application No. 62/338,948, filed on May 19, 2016.
(60) Provisional application No. 62/382,733, filed on Sep. 1, 2016.

(51) Int. Cl. G06K 9/00; G06K 9/62

(52) U.S. Cl. CPC G06K 9/00744; G06K 2009/00738; G06K 9/00771; G06K 9/6288

(57) ABSTRACT

The present disclosure overcomes the limitations of the prior art by providing approaches to marking points of interest in scenes. In one aspect, a Scene of interest is identified based on SceneData provided by a sensor-side technology stack that includes a group of one or more sensor devices. The SceneData is based on a plurality of different types of sensor data captured by the sensor group, and typically requires additional processing and/or analysis of the captured sensor data. A SceneMark marks the Scene of interest or possibly a point of interest within the Scene.

### CROSS-REFERENCE TO RELATED APPLICATION(S)

This application is a continuation of U.S. patent application Ser. No. 15/487,416, “Scene Marking,” filed Apr. 13, 2017; which claims priority under 35 U.S.C. § 119(e) to U.S. Provisional Patent Appl. Ser. No. 62/338,948 “Network of Intelligent Surveillance Sensors” filed May 19, 2016, and to U.S. Provisional Patent Appl. Ser. No. 62/382,733 “Network of Intelligent Surveillance Sensors” filed Sep. 1, 2016. The subject matter of all of the foregoing is incorporated herein by reference in their entirety.

### BACKGROUND

### 1. Field of the Invention

This disclosure relates generally to obtaining, analyzing and presenting information from sensor devices, including for example cameras.

### 2. Description of Related Art

Millions of cameras and other sensor devices are deployed today. There generally is no mechanism to enable computing to easily interact in a meaningful way with content captured by cameras. This results in most data from cameras not being processed in real time and, at best, captured images are used for forensic purposes after an event has been known to have occurred. As a result, a large amount of data storage is wasted to store video that in the end analysis is not interesting. In addition, human monitoring is usually required to make sense of captured videos. There is limited machine assistance available to interpret or detect relevant data in images.

Another problem today is that the processing of information is highly application specific. Applications such as advanced driver assisted systems and security based on facial recognition require custom built software which reads in raw images from cameras and then processes the raw images in a specific way for the target application. The application developers typically must create application-specific software to process the raw video frames to extract the desired information. The application-specific software typically is a full stack beginning with low-level interfaces to the sensor devices and progressing through different levels of analysis to the final desired results. The current situation also makes it difficult for applications to share or build on the analysis performed by other applications.

As a result, the development of applications that make use of networks of sensors is both slow and limited. For example, surveillance cameras installed in an environment typically are used only for security purposes and in a very limited way. This is in part because the image frames that are captured by such systems are very difficult to extract meaningful data from. Similarly, in an automotive environment where there is a network of cameras mounted on a car, the image data captured from these cameras is processed in a way that is very specific to a feature of the car. For example, a forward facing camera may be used only for lane assist. There usually is no capability to enable an application to utilize the data or video for other purposes.

Thus, there is a need for more flexibility and ease in accessing and processing data captured by sensor devices, including images and video captured by cameras.

### SUMMARY

The present disclosure overcomes the limitations of the prior art by providing approaches to marking points of interest in scenes. In one aspect, a Scene of interest is identified based on SceneData provided by a sensor-side technology stack that includes a group of one or more sensor devices. The SceneData is based on a plurality of different types of sensor data captured by the sensor group, and typically requires additional processing and/or analysis of the captured sensor data. A SceneMark marks the Scene of interest or possibly a point of interest within the Scene.

SceneMarks can be generated based on the occurrence of events or the correlation of events or the occurrence of certain predefined conditions. They can be generated synchronously with the capture of data, or asynchronously if for example additional time is required for more computationally intensive analysis. SceneMarks can be generated along with notifications or alerts. SceneMarks preferably summarize the Scene of interest and/or communicate messages about the Scene. They also preferably abstract away from individual sensors in the sensor group and away from specific implementation of any required processing and/or analysis. SceneMarks preferably are defined by a standard.

In another aspect, SceneMarks themselves can yield other related SceneMarks. For example, the underlying SceneData that generated one SceneMark may be further process or analyzed to generate a related SceneMark. These could be two separate SceneMarks, or the related SceneMark could be an updated version of the original SceneMark. The related SceneMark may or may not replaced the original SceneMark. The related SceneMarks preferably refer to each other. In one situation, the original SceneMark may be generated synchronously with the capture of the sensor data, for example because it is time-sensitive or real-time. The related SceneMark may be generated asynchronously, for example because it requires longer computation.

SceneMarks are also data objects that themselves can also be manipulated and analyzed. For example, SceneMarks may be collected and made available for additional processing or analysis by users. They could be browsable, searchable, and filterable. They could be cataloged or made available through a manifest file. They could be organized by source, time location, content, or type of notification or type of alarm. Additional data, including metadata, can be added to the SceneMarks after their initial generation. They can act as summaries or datagrams for the underlying Scenes and SceneData. SceneMarks could be aggregated over many sources.

In one approach, an entity provides intermediation services between sensor devices and requestors of sensor data. The intermediary receives and fulfills the requests for SceneData and also collects and manages the corresponding SceneMarks, which it makes available to future consumers. In one approach, the intermediary is a third party that is operated independently of the SceneData requestors, the sensor groups, and/or the future consumers of the SceneMarks. Availability of the SceneMarks and the underlying SceneData is made available to future consumers, subject to privacy, confidentiality and other limitations. The intermediary may just manage the SceneMarks, or it may itself also generate and/or update SceneMarks. The SceneMark manager preferably does not itself store the underlying SceneData, but provides references for retrieval of the SceneData.

Other aspects include components, devices, systems, improvements, methods, processes, applications, computer readable mediums, and other technologies related to any of the above.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the disclosure have other advantages and features which will be more readily apparent from the following detailed description and the appended claims, when taken in conjunction with the examples shown in the accompanying drawings, in which:

FIG. 1 is a block diagram of a technology stack using Scenes.

FIG. 2A is a diagram illustrating different types of SceneData.

FIG. 2B is a block diagram of a package of SceneData.

FIG. 2C is a timeline illustrating the use of Scenes and SceneMarks.

FIG. 3A (prior art) is a diagram illustrating conventional video capture.

FIG. 3B is a diagram illustrating Scene-based data capture and production.

FIG. 4 is a block diagram of middleware that is compliant with a Scene-based API.

FIG. 5 illustrates an example SceneMode.

FIG. 6A (prior art) illustrates a video stream captured by a conventional surveillance system.

FIGS. 6B-6C illustrate Scene-based surveillance systems.

FIG. 7 is a block diagram of a SceneMark.

FIGS. 8A and 8B illustrate two different methods for generating related SceneMarks.

FIG. 9 is a diagram illustrating the creation of Scenes, SceneData, and SceneMarks.

FIG. 10 is a block diagram of a third party providing intermediation services.

FIG. 11 is a block diagram illustrating a SceneMark manager.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

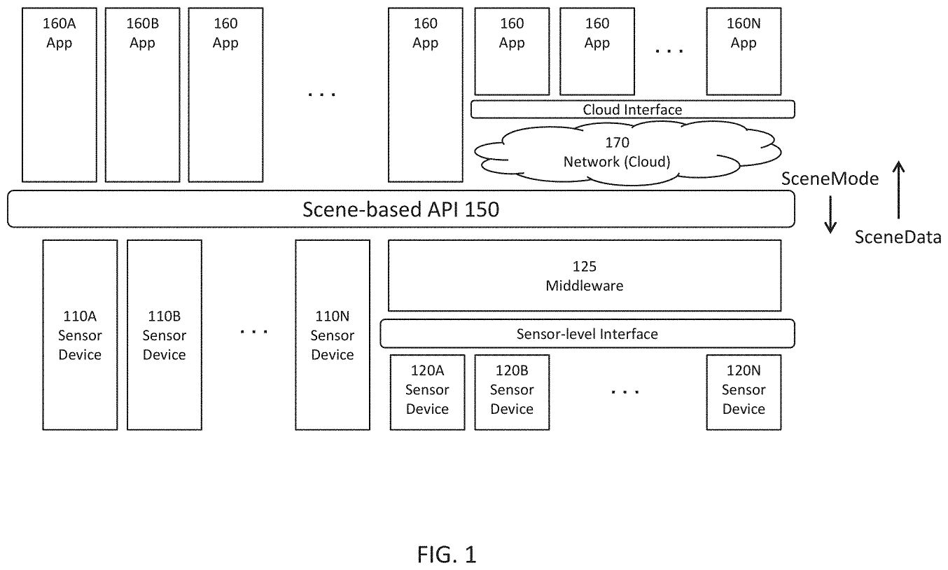

FIG. 1 is a block diagram of a technology stack using Scenes. In this example, there are a number of sensor devices 110A-N, 120A-N that are capable of capturing sensor data. Examples of sensor devices include cameras and other image capture devices, including monochrome, single-color, multi-color, RGB, other visible, IR, 4-color (e.g., RGB+IR), stereo, multi-view, strobed, and high-speed; audio sensor devices, including microphones and vibration sensors; depth sensor devices, including LIDAR, depth by deblur, time of flight and structured light devices; and temperature/thermal sensor devices. Other sensor channels could also be used, for example motion sensors and different types of material detectors (e.g., metal detector, smoke detector, carbon monoxide detector). There are a number of applications 160A-N that consume the data captured by the sensor devices 110, 120.

The technology stack from the sensor devices 110, 120 to the applications 160 organizes the captured sensor data into Scenes, and Scenes of interest are marked by SceneMarks, which are described in further detail below. In this example, the generation of Scenes and SceneMarks is facilitated by a Scene-based API 150, although this is not required. Some of the applications 160 access the sensor data and sensor devices directly through the API 150, and other applications 160 make access through networks which will generically be referred to as the cloud 170. The sensor devices 110, 120 and their corresponding data can also make direct access to the API 150, or can make access through the cloud (not shown in FIG. 1).

In FIG. 1, some of the sensor devices 110 are directly compatible with the Scene-based API 150. For other sensor devices 120, for example legacy devices already in the field, compatibility can be achieved via middleware 125. For convenience, the technology stack from the API 150 to the sensor devices 110, 120 will be referred to as the sensor-side stack, and the technology stack from the API 150 to the applications 160 will be referred to as the application-side stack.

The Scene-based API 150 and SceneMarks preferably are implemented as standard. They abstract away from the specifics of the sensor hardware and also abstract away from implementation specifics for processing and analysis of captured sensor data. In this way, application developers can specify their data requirements at a higher level and need not be concerned with specifying the sensor-level settings (such as F/#, shutter speed, etc.) that are typically required today. In addition, device and module suppliers can then meet those requirements in a manner that is optimal for their products. Furthermore, older sensor devices and modules can be replaced with more capable newer products, so long as compatibility with the Scene-based API 150 is maintained.

FIG. 1 shows multiple applications 160 and multiple sensor devices 110, 120. However, any combinations of applications and sensor devices are possible. It could be a single application interacting with one or more sensor devices, one or more applications interacting with a single sensor device, or multiple applications interacting with multiple sensor devices. The applications and sensor devices may be dedicated or they may be shared. In one use scenario, a large number of sensor devices are available for shared use by many applications, which may desire for the sensor devices to acquire different types of data. Thus, data requests from different applications may be multiplexed at the sensor devices. For convenience, the sensor devices 110, 120 that are interacting with an application will be referred to as a sensor group. Note that a sensor group may include just one device.

The system in FIG. 1 is Scene-based, which takes into consideration the context for which sensor data is gathered and processed. Using video cameras as an example, a conventional approach may allow/require the user to specify a handful of sensor-level settings for video capture: f-number, shutter speed, frames per second, resolution, etc. The video camera then captures a sequence of images using those sensor-level settings, and that video sequence is returned to the user. The video camera has no context as to why those settings were selected or for what purpose the video sequence will be used. As a result, the video camera also cannot determine whether the selected settings were appropriate for the intended purpose, or whether the sensor-level settings should be changed as the scene unfolds or as other sensor devices gather relevant data. The conventional video camera API also does not specify what types of additional processing and analysis should be applied to the captured data. All of that intelligence resides on the application-side of a conventional sensor-level API.

In contrast, human understanding of the real world generally occurs at a higher level. For example, consider a security-surveillance application. A “Scene” in that context may naturally initiate by a distinct onset of motion in an otherwise static room, proceed as human activity occurs, and terminate when everyone leaves and the room reverts to the static situation. The relevant sensor data may come from multiple different sensor channels and the desired data may change as the Scene progresses. In addition, the information desired for human understanding typically is higher level than the raw image frames captured by a camera. For example, the human end user may ultimately be interested in data such as “How many people are there?”, “Who are they?”, “What are they doing?”, “Should the authorities be alerted?” In a conventional system, the application developer would have to first determine and then code this intelligence, including providing individual sensor-level settings for each relevant sensor device.

In the Scene-based approach of FIG. 1, some or all of this is moved from the application-side of the API 150 to the sensor-side of the API, for example into the sensor devices/modules 110, 120, into the middleware 125, or into other components (e.g., cloud-based services) that are involved in generating SceneData to be returned across the API. As one example, the application developer may simply specify different SceneModes, which define what high level data should be returned to the application. This, in turn, will drive the selections and configurations of the sensor channels optimized for that mode, and the processing and analysis of the sensor data. In the surveillance example, the application specifies a Surveillance SceneMode, and the sensor-side technology stack then takes care of the details re: which types of sensor devices are used when, how many frames per second, resolution, etc. The sensor-side technology stack also takes care of the details re: what types of processing and analysis of the data should be performed, and how and where to perform those.

In a general sense, a SceneMode defines a workflow which specifies the capture settings for one or more sensor devices (for example, using CaptureModes as described below), as well as other necessary sensor behaviors. It also informs the sensor-side and cloud-based computing modules in which Computer Vision (CV) and/or AI algorithms are to be engaged for processing the captured data. It also determines the requisite SceneData and possibly also SceneMarks in their content and behaviors across the system workflow.

In FIG. 1, this intelligence resides in the middleware 125 or in the devices 110 themselves if they are smart devices (i.e., compatible with the Scene-based API 150). Auxiliary processing, provided off-device or on a cloud basis, may also implement some of the intelligence required to generate the requested data.

This approach has many possible advantages. First, the application developers can operate at a higher level that preferably is more similar to human understanding. They do not have to be as concerned about the details for capturing, processing or analyzing the relevant sensor data or interfacing with each individual sensor device or each processing algorithm. Preferably, they would specify just a high-level SceneMode and would not have to specify any of the specific sensor-level settings for individual sensor devices or the specific algorithms used to process or analyze the captured sensor data. In addition, it is easier to change sensor devices and processing algorithms without requiring significant rework of applications. For manufacturers, making smart sensor devices (i.e., compatible with the Scene-based API) will reduce the barriers for application developers to use those devices.

Returning to FIG. 1, the data returned across the API 150 will be referred to as SceneData, and it can include both the data captured by the sensor devices, as well as additional derived data. It typically will include more than one type of sensor data collected by the sensor group (e.g., different types of images and/or non-image sensor data) and typically will also include some significant processing or analysis of that data.

This data is organized in a manner that facilitates higher level understanding of the underlying Scenes. For example, many different types of data may be grouped together into timestamped packages, which will be referred to as SceneShots. Compare this to the data provided by conventional camera interfaces, which is just a sequence of raw images. With increases in computing technology and increased availability of cloud-based services, the sensor-side technology stack may have access to significant processing capability and may be able to develop fairly sophisticated SceneData. The sensor-side technology stack may also perform more sophisticated dynamic control of the sensor devices, for example selecting different combinations of sensor devices and/or changing their sensor-level settings as dictated by the changing Scene and the context specified by the SceneMode.

As another example, because data is organized into Scenes rather than provided as raw data, Scenes of interest or points of interest within a Scene may be marked and annotated by markers which will be referred to as SceneMarks. In the security surveillance example, the Scene that is triggered by motion in an otherwise static room may be marked by a SceneMark. SceneMarks facilitate subsequent processing because they provide information about which segments of the captured sensor data may be more or less relevant. SceneMarks also distill information from large amounts of sensor data. Thus, SceneMarks themselves can also be cataloged, browsed, searched, processed or analyzed to provide useful insights.

A SceneMark is an object which may have different representations. Within a computational stack, it typically exists as an instance of a defined SceneMark class, for example with its data structure and associated methods. For transport, it may be translated into the popular JSON format, for example. For permanent storage, it may be turned into a file or an entry into a database.

The following is an example of a SceneMark expressed as a manifest file. It includes metadata (for example SceneMark ID, SceneMode session ID, time stamp and duration), available SceneData fields and the URLs to the locations where the SceneData is stored.

```
{
  _id: ObjectId(“4c4b1476238d3b4dd5003981”),
  account_id: “dan@scenera.net”,
  scene_mark_timestamp: ISODate(“2016-07-01T18:12:40.443Z”),
  scene_mark_priority: 1,
  camera_id: 1,
  scene_mode:”security:residence”,
  small_thumbnail_path: “/thumbnail/small/29299.jpeg”,
  large_thumbnail_path: [“/thumbnail/large/29299_1.jpeg”,
  “/thumbnail/large/29299_2.jpeg”, “/thumbnail/large/29299_3.jpeg”,
  “/thumbnail/large/29299_4.jpeg”]
  video_path: “/video/29299.mp4”,
  events: [
    {
      event_timestamp: ISODate(“2016-07-01T18:12:40.443Z”),
      event_data: {
        event_type : “motion detection”,
        . . .
      }
    }
  ]
}
```

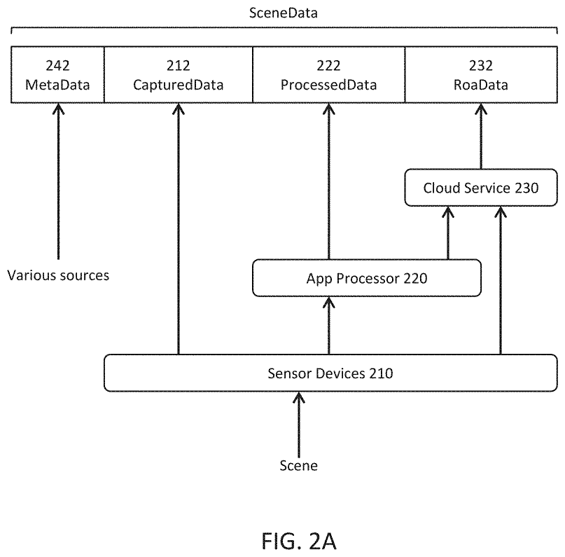

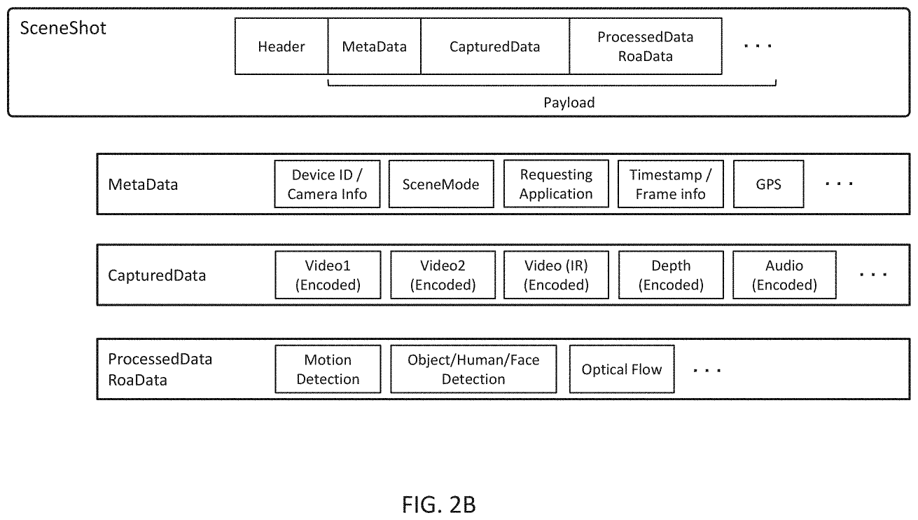

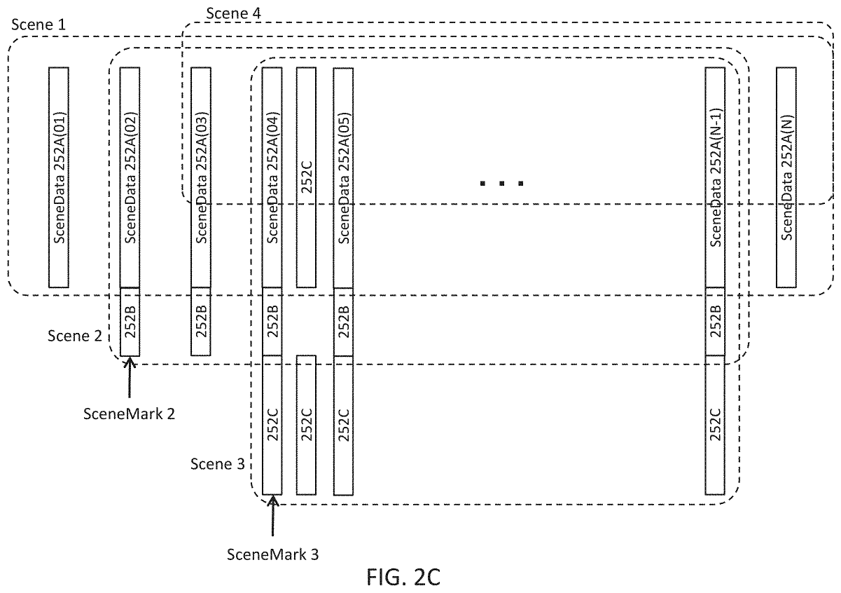

FIG. 2A is a diagram illustrating different types of SceneData. The base data captured by sensor channels 210 will be referred to as CapturedData 212. Within the video context, examples of CapturedData include monochrome, color, infrared, and images captured at different resolutions and frame rates. Non-image types of CapturedData include audio, temperature, ambient lighting or luminosity and other types of data about the ambient environment. Different types of CapturedData could be captured using different sensor devices, for example a visible and an infrared camera, or a camera and a temperature monitor. Different types of CapturedData could also be captured by a single sensor device with multiple sensors, for example two separate on-board sensor arrays. A single sensor could also be time multiplexed to capture different types of CapturedData—changing the focal length, flash, resolution, etc. for different frames.

CapturedData can also be processed, preferably on-board the sensor device, to produce ProcessedData 222. In FIG. 2A, the processing is performed by an application processor 220 that is embedded in the sensor device. Examples of ProcessedData 222 include filtered and enhanced images, and the combination of different images or with other data from different sensor channels. Noise-reduced images and resampled images are some examples. As additional examples, lower resolution color images might be combined with higher resolution black and white images to produce a higher resolution color image. Or imagery may be registered to depth information to produce an image with depth or even a three-dimensional model. Images may also be processed to extract geometric object representations. Wider field of view images may be processed to identify objects of interest (e.g., face, eyes, weapons) and then cropped to provide local images around those objects. Optical flow may be obtained by processing consecutive frames for motion vectors and frame-to-frame tracking of objects. Multiple audio channels from directed microphones can be processed to provide localized or 3D mapped audio. ProcessedData preferably can be data processed in real time while images are being captured. Such processing may happen pixel by pixel, or line by line, so that processing can begin before the entire image is available.

SceneData can also include different types of MetaData 242 from various sources. Examples include timestamps, geolocation data, ID for the sensor device, IDs and data from other sensor devices in the vicinity, ID for the SceneMode, and settings of the image capture. Additional examples include information used to synchronize or register different sensor data, labels for the results of processing or analyses (e.g., no weapon present in image, or faces detected at locations A, B and C), and pointers to other related data including from outside the sensor group.

Any of this data can be subject to further analysis, producing data that will be referred to generally as ResultsOfAnalysisData, or RoaData 232 for short. In the example of FIG. 2A, the analysis is artificial intelligence/machine learning performed by cloud resources 230. This analysis may also be based on large amounts of other data. Compared to RoaData, ProcessedData typically is more independent of the SceneMode, producing intermediate building blocks that may be used for many different types of later analysis. RoaData tends to be more specific to the end function desired. As a result, the analysis for RoaData can require more computing resources. Thus, it is more likely to occur off-device and not in real-time during data capture. RoaData may be returned asynchronously back to the scene analysis for further use.

SceneData also has a temporal aspect. In conventional video, a new image is captured at regular intervals according to the frame rate of the video. Each image in the video sequence is referred to as a frame. Similarly, a Scene typically has a certain time duration (although some Scenes can go on indefinitely) and different “samples” of the Scene are captured/produced over time. To avoid confusion, these samples of SceneData will be referred to as SceneShots rather than frames, because a SceneShot may include one or more frames of video. The term SceneShot is a combination of Scene and snapshot.

Compared to conventional video, SceneShots can have more variability. SceneShots may or may not be produced at regular time intervals. Even if produced at regular time intervals, the time interval may change as the Scene progresses. For example, if something interesting is detected in a Scene, then the frequency of SceneShots may be increased. A sequence of SceneShots for the same application or same SceneMode also may or may not contain the same types of SceneData or SceneData derived from the same sensor channels in every SceneShot. For example, high resolution zoomed images of certain parts of a Scene may be desirable or additional sensor channels may be added or removed as a Scene progresses. As a final example, SceneShots or components within SceneShots may be shared between different applications and/or different SceneModes, as well as more broadly.

FIG. 2B is a block diagram of a SceneShot. This SceneShot includes a header. It includes the following MetaData: sensor device IDs, SceneMode, ID for the requesting application, timestamp, GPS location stamp. The data portion of SceneShot also includes the media data segment such as the CapturedData which may include color video from two cameras, IR video at a different resolution and frame rate, depth measurements, and audio. It also includes the following ProcessedData and/or RoaData: motion detection, object/human/face detections, and optical flow. Unlike conventional video in which each sequential image generally contains the same types of data, the next SceneShot for this Scene may or may not have all of these same components. Note that FIG. 2B is just an example. For example, the actual sensor data may be quite bulky. As a result, this data may be stored by middleware or on the cloud, and the actual data packets of a SceneShot may include pointers to the sensor data rather than the raw data itself. As another example, MetaData may be dynamic (i.e., included and variable with each SceneShot). However, if the MetaData does not change frequently, it may be transmitted separately from the individual SceneShots or as a separate channel.

FIG. 2C is a timeline illustrating the organization of SceneShots into Scenes. In this figure, time progresses from left to right. The original Scene 1 is for an application that performs after-hours surveillance of a school. SceneData 252A is captured/produced for this Scene 1. SceneData 252A may include coarse resolution, relative low frame rate video of the main entry points to the school. SceneData 252A may also include motion detection or other processed data that may indicative of potentially suspicious activity. In FIG. 2C, the SceneShots are denoted by the numbers in parenthesis (N), so 252A(01) is one SceneShot, 252A(02) is the next SceneShot and so on.

Possibly suspicious activity is detected in SceneShot 252A(01), which is marked by SceneMark 2 and a second Scene 2 is spawned. This Scene 2 is a sub-Scene to Scene 1. Note that the “sub-” refers to the spawning relationship and does not imply that Scene 2 is a subset of Scene 1, in terms of SceneData or in temporal duration. In fact, this Scene 2 requests additional SceneData 252B. Perhaps this additional SceneData is face recognition. Individuals detected on the site are not recognized as authorized, and this spawns Scene 3 (i.e., sub-sub-Scene 3) marked by SceneMark 3. Scene 3 does not use SceneData 252B, but it does use additional SceneData 252C, for example higher resolution images from cameras located throughout the site and not just at the entry points. The rate of image capture is also increased. SceneMark 3 triggers a notification to authorities to investigate the situation.

In the meantime, another unrelated application creates Scene 4. Perhaps this application is used for remote monitoring of school infrastructure for early detection of failures or for preventative maintenance. It also makes use of some of the same SceneData 252A, but by a different application for a different purpose.

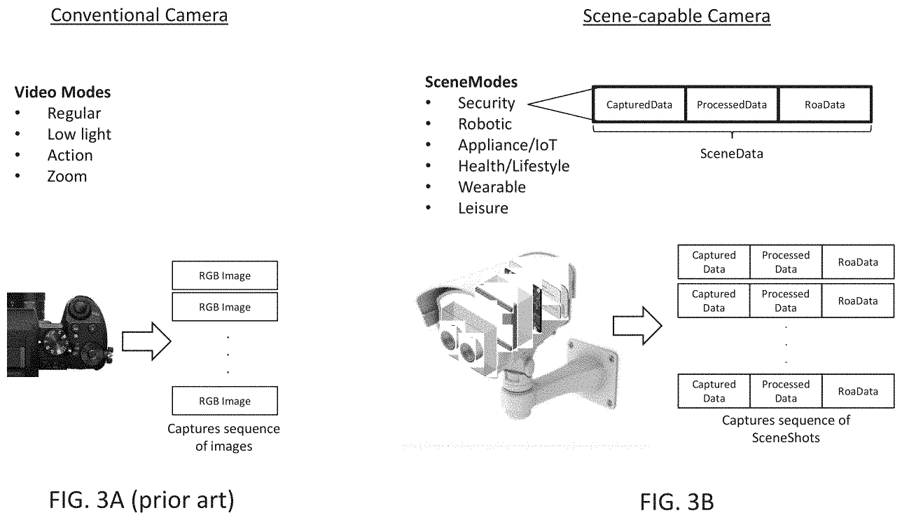

FIGS. 3A and 3B compare conventional video capture with Scene-based data capture and production. FIG. 3A (prior art) is a diagram illustrating conventional video capture. The camera can be set to different modes for video capture: regular, low light, action and zoom modes in this example. In low light mode, perhaps the sensitivity of the sensor array is increased or the exposure time is increased. In action mode, perhaps the aperture is increased and the exposure time is decreased. The focal length is changed for zoom mode. These are changes in the sensor-level settings for camera. Once set, the camera then captures a sequence of images at these settings.

FIG. 3B is a diagram illustrating Scene-based data capture and production. In this example, the SceneModes are Security, Robotic, Appliance/IoT, Health/Lifestyle, Wearable and Leisure. Each of these SceneModes specify a different set of SceneData to be returned to the application, and that SceneData can be a combination of different types of sensor data, and processing and analysis of that sensor data. This approach allows the application developer to specify a SceneMode, and the sensor-side technology stack determines the group of sensor devices, sensor-level settings for those devices, and workflow for capture, processing and analysis of sensor data. The resulting SceneData is organized into SceneShots, which in turn are organized into Scenes marked by SceneMarks.

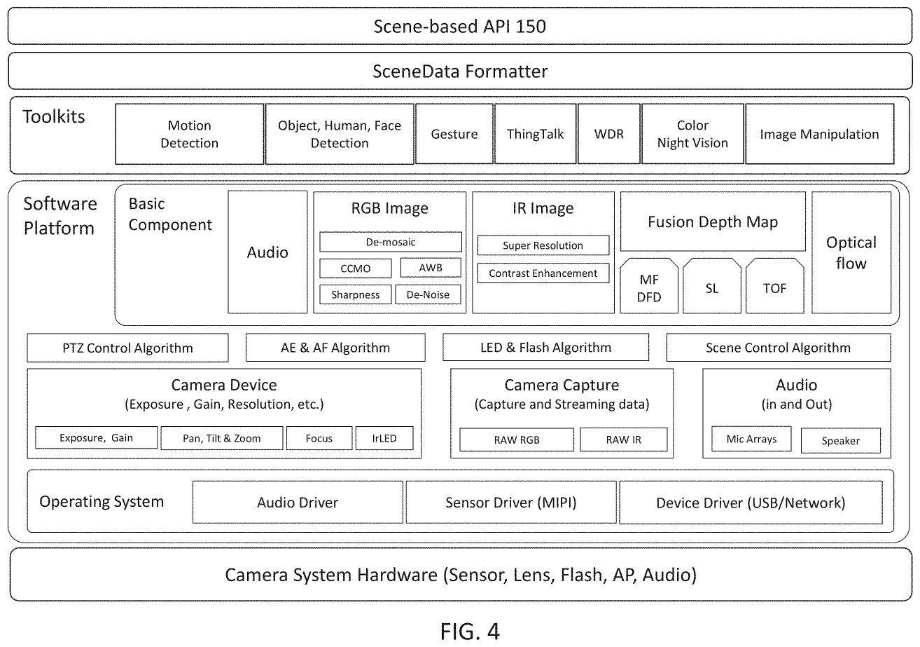

Returning to FIG. 1, the applications 160 and sensor channels 110, 120 interface through the Scene-based API 150. The applications 160 specify their SceneModes and the sensor-side technology stack then returns the corresponding SceneData. In many cases, the sensor devices themselves may not have full capability to achieve this. FIG. 4 is a block diagram of middleware 125 that provides functionality to return SceneData requested via a Scene-based API 150. This middleware 125 converts the SceneMode requirements to sensor-level settings that are understandable by the individual sensor devices. It also aggregates, processes and analyzes data in order to produce the SceneData specified by the SceneMode.

The bottom of this this stack is the camera hardware. The next layer up is the software platform for the camera. In FIG. 4, some of the functions are listed by acronym to save space. PTZ refers to pan, tilt & zoom; and AE & AF refer to auto expose and auto focus. The RGB image component includes de-mosaicking, CCMO (color correction matrix optimization), AWB (automatic white balance), sharpness filtering and noise filtering/improvement. The fusion depth map may combine depth information from different depth sensing modalities. In this example, those include MF DFD (Multi Focus Depth by Deblur, which determines depth by comparing blur in images taken with different parameters, e.g., different focus settings), SL (depth determined by projection of Structured Light onto the scene) and TOF (depth determined by Time of Flight). Further up are toolkits and then a formatter to organize the SceneData into SceneShots. In the toolkits, WDR refers to wide dynamic range.

In addition to the middleware, the technology stack may also have access to functionality available via networks, e.g., cloud-based services. Some or all of the middleware functionality may also be provided as cloud-based services. Cloud-based services could include motion detection, image processing and image manipulation, object tracking, face recognition, mood and emotion recognition, depth estimation, gesture recognition, voice and sound recognition, geographic/spatial information systems, and gyro, accelerometer or other location/position/orientation services.

Whether functionality is implemented on-device, in middleware, in the cloud or otherwise depends on a number of factors. Some computations are so resource-heavy that they are best implemented in the cloud. As technology progresses, more of those may increasingly fall within the domain of on-device processing. It remains flexible in consideration of the hardware economy, latency tolerance as well as specific needs of the desired SceneMode or the service.

Generally, the sensor device preferably will remain agnostic of any specific SceneMode, and its on-device computations may focus on serving generic, universally utilizable functions. At the same time, if the nature of the service warrants, it is generally preferable to reduce the amount of data transport required and to also avoid the latency inherent in any cloud-based operation.

The SceneMode provides some context for the Scene at hand, and the SceneData returned preferably is a set of data that is more relevant (and less bulky) than the raw sensor data captured by the sensor channels. In one approach, Scenes are built up from more atomic Events. In one model, individual sensor samples are aggregated into SceneShots, Events are derived from the SceneShots, and then Scenes are built up from the Events. SceneMarks are used to mark Scenes of interest or points of interest within a Scene. Generally speaking, a SceneMark is a compact representation of a recognized Scene of interest based on intelligent interpretation of the time- and/or location-correlated aggregated Events.

The building blocks of Events are derived from monitoring and analyzing sensory input (e.g. output from a video camera, a sound stream from a microphone, or data stream from a temperature sensor). The interpretation of the sensor data as Events is framed according to the context (is it a security camera or a leisure camera, for example). Examples of Events may include the detection of a motion in an otherwise static environment, recognition of a particular sound pattern, or in a more advanced form recognition of a particular object of interest (such as a gun or an animal). Events can also include changes in sensor status, such as camera angle changes, whether intended or not. General classes of Events includes motion detection events, sound detection events, device status change events, ambient events (such as day to night transition, sudden temperature drop, etc.), and object detection events (such as presence of a weapon-like object). The identification and creation of Events could occur within the sensor device itself. It could also be carried out by processor units in the cloud.

The interpretation of Events depends on the context of the Scene. The appearance of a gun-like object captured in a video frame is an Event. It is an “alarming” Event if the environment is a home with a toddler and would merit elevating the status of the Scene (or spawning another Scene, referred to as a sub-Scene) to require immediate reaction from the monitor. However, if the same Event is registered in a police headquarters, the status of the Scene may not be elevated until further qualifications were met.

As another example, consider a security camera monitoring the kitchen in a typical household. Throughout the day, there may be hundreds of Events. The Events themselves preferably are recognized without requiring sophisticated interpretation that would slow down processing. Their detection preferably is based on well-established but possibly specialized algorithms, and therefore can preferably be implemented either on-board the sensor device or as the entry level cloud service. Given that timely response is important and the processing power at these levels is weak, it is preferable that the identification of Events is not burdened with higher-level interpretational schemes.

As such, an aggregation of Events may be easily partitioned into separate Scenes either through their natural start- and stop-markers (such as motion sensing, light on or off, or simply by an arbitrarily set interval). Some of them may still leave ambiguity. The higher-level interpretation of Events into Scenes may be recognized and managed by the next level manager that oversees thousands of Events streamed to it from multiple sensor devices. The same Event such as a motion detection may reach different outcomes as a potential Scene if the context (SceneMode) is set as a Daytime Office or a Night Time Home during Vacation. In the kitchen example, enhanced sensitivity to some signature Events may be appropriate: detection of fire/smoke, light from refrigerator (indicating its door is left open), in addition to the usual burglary and child-proof measures. Face recognition may also be used to eliminate numerous false-positive notifications. A Scene involving a person who appears in the kitchen after 2 am, engaged in opening the freezer and cooking for a few minutes, may just be a benign Scene once the person is recognized as the home owner's teenage son. On the other hand, a seemingly harmless but persistent light from the refrigerator area in an empty home set for the Vacation SceneMode may be a Scene worth immediate notification.

Note that Scenes can also be hierarchical. For example, a Motion-in-Room Scene may be started when motion is detected within a room and end when there is no more motion, with the Scene bracketed by these two timestamps. Sub-Scenes may occur within this bracketed timeframe. A sub-Scene of a human argument occurs (e.g. delimited by ArgumentativeSoundOn and Off time markers) in one corner of the room. Another sub-Scene of animal activity (DogChasingCatOn & Off) is captured on the opposite side of the room. This overlaps with another sub-Scene which is a mini crisis of a glass being dropped and broken. Some Scenes may go on indefinitely, such as an alarm sound setting off and persisting indefinitely, indicating the lack of any human intervention within a given time frame. Some Scenes may relate to each other, while others have no relations beyond itself.

Depending on the application, the Scenes of interest will vary and the data capture and processing will also vary. Examples of SceneModes include a Home Surveillance, Baby Monitoring, Large Area (e.g., Airport) Surveillance, Personal Assistant, Smart Doorbell, Face Recognition, and a Restaurant Camera SceneMode. Other examples include Security, Robot, Appliance/IoT (Internet of Things), Health/Lifestyle, Wearables and Leisure SceneModes.

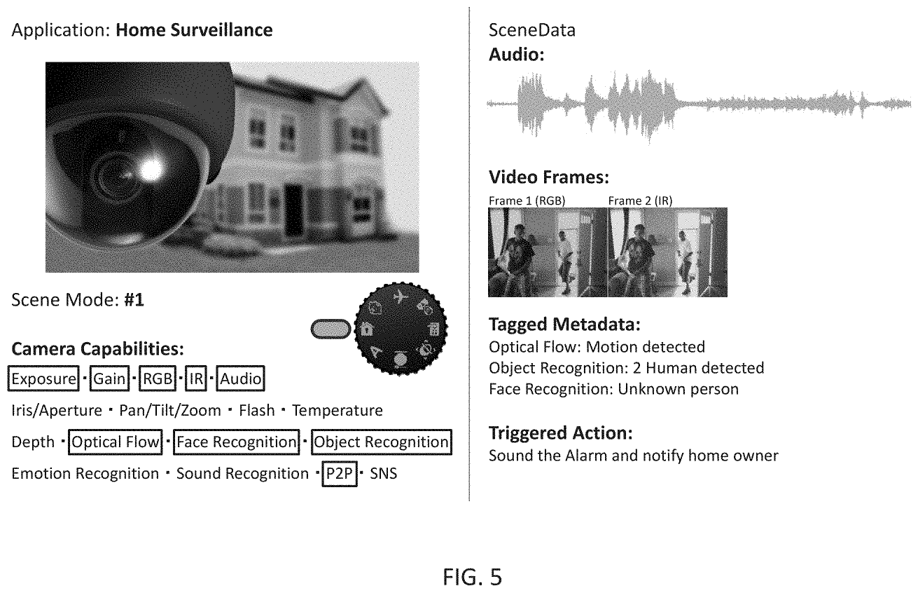

FIG. 5 illustrates an example SceneMode #1, which in this example is used by a home surveillance application. In the left-hand side of FIG. 5, each of the icons on the dial represents a different SceneMode. In FIG. 5, the dial is set to the house icon which indicates SceneMode #1. The SceneData specified by this SceneMode is shown in the right-hand side of FIG. 5. The SceneData includes audio, RGB frames, IR frames. It also includes metadata for motion detection (from optical flow capability), human detection (from object recognition capability) and whether the humans are known or strangers (from face recognition capability). To provide the required SceneData, the sensor-side technology stack typically will use the image and processing capabilities which are boxed on the left-hand side of FIG. 5: exposure, gain, RGB, IR, audio, optical flow, face recognition, object recognition and P2P, and sets parameters for these functions according to the mode. Upon detection of unrecognized humans, the application sounds an alarm and notifies the owner. The use of SceneData beyond just standard RGB video frames helps to achieve automatic quick detection of intruders, triggering appropriate actions.

In one approach, SceneModes are based on more basic building blocks called CaptureModes. In general, each SceneMode requires the sensor devices it engages to meet several functional specifications. It may need to set a set of basic device attributes and/or activate available CaptureMode(s) that are appropriate for meeting its objective. In certain cases, the scope of a given SceneMode is narrow enough and strongly tied to the specific CaptureMode, such as Biometric (described in further detail below). In such cases, the line between the SceneMode (on the app/service side) and the CaptureMode (on the device) may be blurred. However, it is to be noted that the CaptureModes are strongly tied to hardware functionalities on the device, agnostic of their intended use(s), and thus remain eligible inclusive of multiple SceneMode engagements. For example, the Biometric CaptureMode may also be used in other SceneModes beyond just the Biometric SceneMode.

Other hierarchical structures are also possible. For example, security might be a top-level SceneMode, security.domestic is a second-level SceneMode, security.domestic.indoors is a third-level SceneMode, and security.domestic.indoors.babyroom is a fourth-level SceneMode. Each lower level inherits the attributes of its higher level SceneModes. Additional examples and details of Scenes, SceneData and SceneModes are described in U.S. patent application Ser. No. 15/469,380 “Scene-based Sensor Networks”, which is incorporated by reference herein.

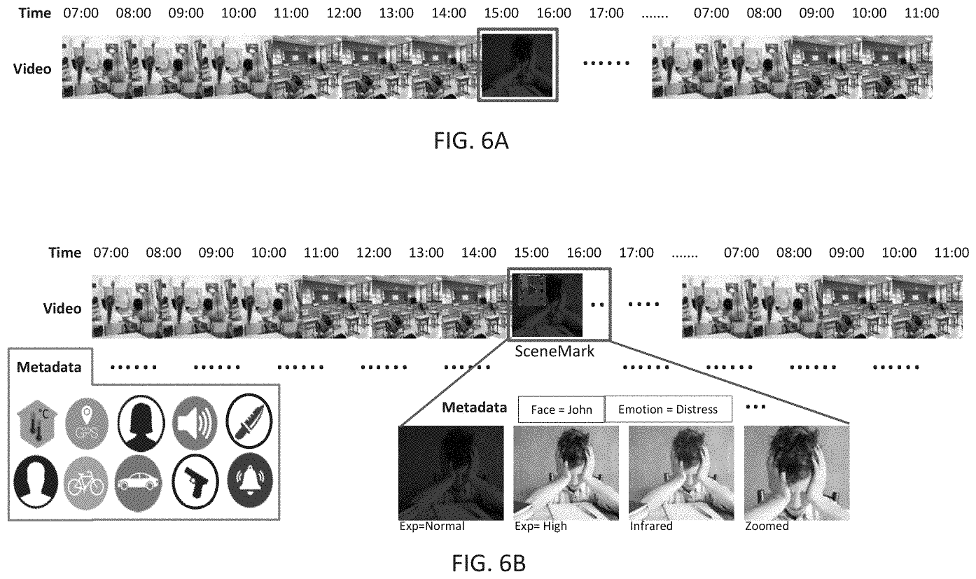

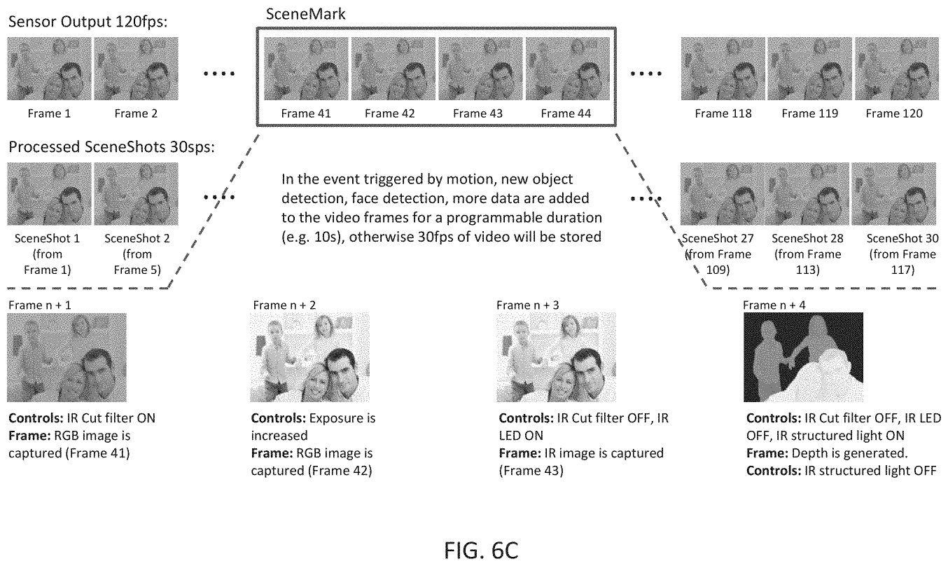

FIGS. 6A-6C illustrate a comparison of a conventional surveillance system with one using Scenes and SceneMarks. FIG. 6A (prior art) shows a video stream captured by a conventional surveillance system. In this example, the video stream shows a child in distress at 15:00. This was captured by a school surveillance system but there was no automatic notification and the initial frames are too dark. The total number of video frames captured in a day (10 hours) at a frame rate of 30 fps=10 hours×60×60×30 fps=1.16 million frames. Storing and searching through this library of video is time consuming and costly. The abnormal event is not automatically identified and not identified in real-time. In this example, there was bad lighting condition when captured and the only data is the raw RGB video data. Applications and services must rely on the raw RGB stream.

FIG. 6B shows the same situation, but using Scenes and SceneMarks. In this example, the initial Scene is defined as the school during school hours, and the initial SceneMode is tailored for general surveillance of a large area. When in this SceneMode, there is an Event of sound recognition that identifies a child crying. This automatically generates a SceneMark for the school Scene at 15:00. Because the school Scene is marked, review of the SceneShots can be done more quickly.

The Event also spawns a sub-Scene for the distressed child using a SceneMode that captures more data. The trend for sensor technology is towards faster frame rates with shorter capture times (faster global shutter speed). This enables the capture of multiple frames which are aggregated into a single SceneShot, or some of which is used as MetaData. For example, a camera that can capture 120 frames per second (fps) can provide 4 frames for each SceneShot, where the Scene is captured at 30 SceneShots per second. MetaData may also be captured by other devices, such as IoT devices. In this example, each SceneShot includes 4 frames: 1 frame of RGB with normal exposure (which is too dark), 1 frame of RGB with adjusted exposure, 1 frame of IR, and 1 frame zoomed in. The extra frames allow for better face recognition and emotion detection. The face recognition and emotion detection results and other data are tagged as part of the MetaData. This MetaData can be included as part of the SceneMark. This can also speed up searching by keyword. A notification (e.g., based on the SceneMark) is sent to the teacher, along with a thumbnail of the scene and shortcut to the video at the marked location. The SceneData for this second Scene is a collection of RGB, IR, zoom-in and focused image streams. Applications and services have access to more intelligent and richer scene data for more complex and/or efficient analysis.

FIG. 6C illustrates another example where a fast frame rate allows multiple frames to be included in a single SceneData SceneShot. In this example, the frame rate for the sensor device is 120 fps, but the Scene rate is only 30 SceneShots per second, so there are 4 frames for every SceneShot. Under normal operation, every fourth frame is captured and stored as SceneData for the Scene. However, upon certain triggers, additional Scenes are spawned and additional frames are captured so that SceneData for these sub-Scenes may include multiple frames captured under different conditions. These are marked by SceneMarks. In this example, the camera is a 3-color camera, but which can be filtered to effectively capture an IR image. The top row shows frames that can be captured by the camera at its native frame rate of 120 frames per second. The middle row shows the SceneShots for the normal Scene, which runs indefinitely. The SceneShots are basically every fourth frame of the raw sensor output. The bottom row shows one SceneShot for a sub-Scene spawned by motion detection in the parent Scene at Frame 41 (i.e., SceneShot 11). In the sub-Scene, the SceneShots are captured at 30 SceneShots per second. However, each SceneShot includes four images. Note that some of the frames are used in both Scenes. For example, Frame 41 is part of the normal Scene and also part of the Scene triggered by motion.

SceneMarks typically are generated after a certain level of cognition has been completed, so they typically are generated initially by higher layers of the technology stack. However, precursors to SceneMarks can be generated at any point. For example, a SceneMark may be generated upon detection of an intruder. This conclusion may be reached only after fairly sophisticated processing, progressing from initial motion detection to individual face recognition, and the final and definitive version of a SceneMark may not be generated until that point. However, the precursor to the SceneMark may be generated much lower in the technology stack, for example by the initial motion detection and may be revised as more information is obtained down the chain or supplemented with additional SceneMarks.

Generally speaking, a SceneMark is a compact representation of a recognized Scene of interest based on intelligent interpretation of the time- and/or location-correlated aggregated events. SceneMarks may be used to extract and present information pertinent to consumers of the sensor data in a manner that preferably is more accurate and more convenient than is currently available. SceneMarks may also be used to facilitate the intelligent and efficient archival/retrieval of detailed information, including the raw sensor data. In this role, SceneMarks operate as a sort of index into a much larger volume of sensor data. A SceneMark may be delivered in a push notification. However it can also be a simple data structure which may be accessed from a server.

As a computational entity, SceneMarks can define both the data-schema and the collection of methods for manipulating its content as well as their aggregates. To use the computational parlance, SceneMarks may be implemented as an instance of the SceneMark class and, within the computational stack, it exists as an object, created and flowing through various computational nodes, and either purged or archived into a database. When deemed notification-worthy, its data in its entirety or in an abridged form, may be parceled to subscribers of its notification service. In addition to acting as an information carrier through the computational stack, SceneMarks also represent high-quality information for end users extracted from the bulk sensor data. Therefore, it has part of its data suitably structured to enable sophisticated sorting, filtering, and presentation processing. Its data content and scope preferably allow requirements to be met to facilitate practices such as cloud-based synchronization, granulated among multiple consumers of its content.

It is typical for a SceneMark to include the following components: 1) a message, 2) supporting data (often implemented as a reference to supporting data) and 3) its provenance. A SceneMark may be considered to be a vehicle for communicating a message or a situation (e.g., a security alert based on a preset context) to consumers of the SceneData. To bolster its message, the SceneMark typically includes relevant data assets (such as a thumbnail image, soundbite, etc.) as well as links/references to more substantial SceneData items. The provenance portion establishes where the SceneMark came from, and uniquely identifies itself: unique ID for the mark, time stamps (its generation, last modification, in- and out-times, etc.), and references to source device(s) and the SceneMode under which it is generated. The message, the main content of the SceneMark, should specify its nature in the set context: whether it is a high level security/safety alarm, or is about a medium level scene of note, or is related to a device-status change. It may also include the collection of events giving rise to the SceneMark but, more typically, will include just the types of events. The SceneMark preferably also has lightweight assets to facilitate presentation of the SceneMark in end user applications (thumbnail, color-coded flags, etc.) as well as references to the underlying supporting material—such as a URL (or other type of pointer or reference) to the persistent data objects in the cloud-stack such as relevant video stream fragment(s) including depth-map or optical flow representation of the same, recognized objects (e.g. their types and bounding boxes). The objects referenced in a SceneMark may be purged in the unspecified future. Therefore, consumers of SceneMarks preferably should include provisions to deal with such a case.

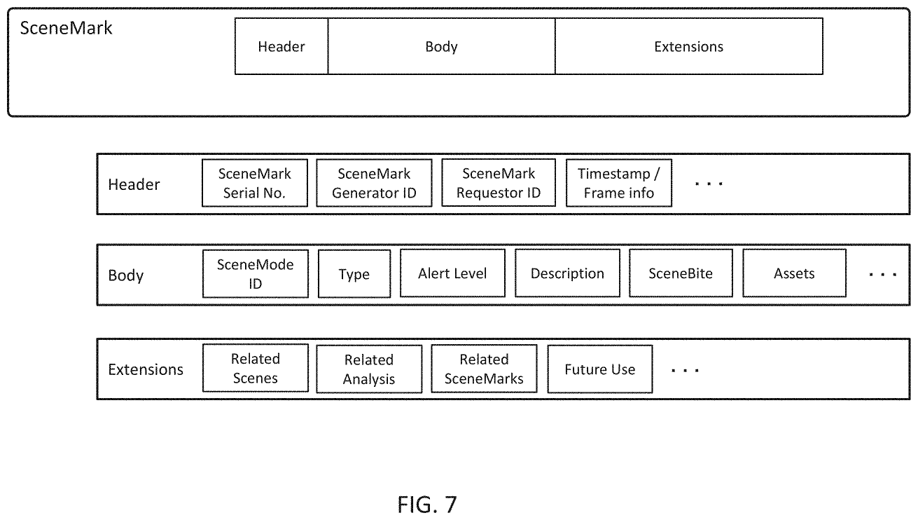

FIG. 7 is a block diagram of a SceneMark. In this example, the SceneMark includes a header, a main body and an area for extensions. The header identifies the SceneMark. The body contains the bulk of the “message” of the SceneMark. The header and body together establish the provenance for the SceneMark. Supporting data may be included in the body if fairly important and not too lengthy. Alternately, it (or a reference to it) may be included in the extensions.

In this example, the header includes an ID (or a set of IDs) and a timestamp. The ID (serial number in FIG. 7) should uniquely identify the SceneMark, for example it could be a unique serial number appropriately managed by entities responsible for its creation within the service. Another ID in the header (Generator ID in FIG. 7) preferably provides information about the source of the SceneMark and its underlying sensor data. The device generating the SceneMark typically is easily identified. In some cases, it may also be useful to traverse farther down the source chain to include intermediate entities that have processed or analyzed the SceneData or even the individual sensor devices that captured the underlying sensor data. The header may also include an ID (the Requestor ID in FIG. 7) for the service or application requesting the related SceneData, thus leading to generation of the SceneMark. In one embodiment, the ID takes the form RequestorID-GeneratorID-SerialNumber, where the different IDs are delimited by “—.”

FIG. 7 is just an example. Other or alternate IDs may also be included. For example, IDs may be used to identify the service(s) and service provider(s) involved in requesting or providing the SceneData and/or SceneMark, applications or type of applications requesting the SceneMark, various user accounts—of the requesting application or of the sensor device for example, the initial request to initiate a SceneMode or Scene, or the trigger or type of trigger that caused the generation of the SceneMark.

For timestamp information, many situations are simple enough that only a single timestamp will be sufficient. Other situations may be more complex and benefit from several timestamps or other temporal attributes (e.g., duration of an event, or time period for a recurring event). The creation of the SceneMark itself may occur at a delayed time, especially if its nature is based on a time-consuming analysis. Therefore, the header may include a timestamp tCreation to mark the specific moment when the SceneMark was created. As described below, SceneMarks themselves may be changed over time. Thus, the header may also include a tLastModification timestamp to indicate a time of last modification.

More meaningful timestamps include tIn and tOut to indicate the beginning and end of an Event or Scene. If there is no meaningful duration, one approach is to set tIn=tOut. The tIn and tOut timestamps for a Scene may be derived from the tIn and tOut timestamps for the Events defining the Scene. In addition to timestamps, the SceneMark could also include geolocation data.

In the example of FIG. 7, the body includes a SceneMode ID, SceneMark Type, SceneMark Alert Level, Short Description, and Assets and SceneBite. Since SceneMarks typically are generated by an analytics engine which operates in the context of a specific SceneMode, a SceneMark should identify under which SceneMode it had been generated. The SceneMode ID may be inherited from its creator module, since the analytics routine responsible for its creation should have been passed the SceneMode information. A side benefit of including this information is that it will quickly allow filtering of all SceneMarks belonging to a certain SceneMode/subMode in a large scale application. For example, the cloud stack may maintain a mutable container for all active SceneMarks at a given time. A higher level AI module may oversee the ins and outs of such SceneMarks (potentially spanning multiple SceneModes) and interpret what is going on beyond the scope of an isolated SceneMode/SceneMark.

The SceneMark Type specifies what kind of SceneMark it is. This may be represented by an integer number or a pair, with the first number determining different classes: e.g., 0 for generic, 1 for device status change alert, 2 for security alert, 3 for safety alert, etc., and the second number determining specific types within each class.

The SceneMark Alert Level provides guidance for the end user application regarding how urgently to present the SceneMark. The SceneMode will be one factor in determining Alert Level. For example, a SceneMark reporting a simple motion should set off a high level of alert if it is in the Infant Room monitoring context, while it may be ignored in a busy office environment. Therefore, both the sensory inputs as well as the relevant SceneMode(s) should be taken into account when algorithmically coming up with a number for the Alert Level. In specialized applications, customized alert criteria may be used. In an example where multiple end users make use of the same set of sensor devices and technology stack, each user may choose which SceneMode alerts to subscribe to, and further filter the level and type of SceneMark alerts of interest.

In cases where SceneMarks are defined by a standard, combination of the SceneMode ID and its flag(s), the Type and Alert Level typically will provide a compact interpretational context and enable applications to present SceneMark aggregates in various forms with efficiency. For example, this can be used to advantage by further machine intelligence analytics of SceneData aggregated over multiple users.

The SceneMark Description preferably is a human-friendly (e.g. brief text) description of the SceneMark.

Assets and SceneBite are data such as images and thumbnails. “SceneBite” is analogous to a soundbite for a Scene. It is a lightweight representation of the SceneMark, such as a thumbnail image or short audio clip. Assets are the heavier underlying assets. The computational machinery behind the SceneMark generation also stores these digital assets. The main database that archives the SceneMarks and these assets are expected to maintain stable references to the assets and may include some of the assets as part of relevant SceneMark(s), either by direct incorporation or through references. The type and the extent of the Assets for a SceneMark depend on the specific SceneMark. Therefore, the data structure for Assets may be left flexible such as an encoded json block. Applications may then retrieve the assets from parsing the block and fetching the items using the relevant URLs, for example.

At the same time, it may be useful to single out a representative asset of a certain type and allocate its own slot within the SceneMark for efficient access (i.e., the SceneBite). A set of one or more small thumbnail images, for example, may serve as a compact visual representation of SceneMarks of many kinds, while a short audiogram may serve for audio-derived SceneMarks. If the SceneMark is reporting a status change of a particular sensor device, it may be more appropriate to include a block of data that represents the snapshot of the device states at the time. Unlike the Assets block of data, which could include either the asset or a reference, the SceneBite preferably carries the actual data of sizes within a reasonable upper bound.

In the example of FIG. 7, extensions permit the extension of the basic SceneMark data structure. This allows further components that will allow more sophisticated analytics via making each SceneMark as a node in its own network as well as allocating more detailed information about its material. Once a SceneMark transits from an isolated entity to a nodal member of a network, e.g. carries its own genealogical structure, several benefits may be realized. First, it becomes efficient to obtain a cluster of related SceneMarks by traversing the nodal connections without having to parse its content—i.e. extra intelligence as obtained during their creation is already encoded into their network structure. Data purging and other SceneMark management procedures also benefit from the relational information.

In some cases, it may be useful for SceneMarks to be concatenated into manifest files. A manifest file contains a set of descriptors and references to data objects that represent a certain time duration of SceneData. The manifest can then operate as a timeline or time index which allows applications to search through the manifest for a specific time within a Scene and then play back that time period from the Scene. In the case of a manifest containing SceneMarks, an application can search through the Manifest to locate a SceneMark that may be relevant. For example the application could search for a specific time, or for all SceneMarks associated with a specific event. A SceneMark may also reference manifest files from other standards, such as HLS or DASH for video and may reference specific chunks or times within the HLS or DASH manifest file.

One possible extension is the recording of relations between SceneMarks. Relations can occur at different levels. The relation may exist between different Scenes, and the SceneMarks are just SceneMarks for the different Scenes. For example, a parent Scene may spawn a sub-Scene. SceneMarks may be generated for the parent Scene and also for the sub-Scene. It may be useful to indicate that these SceneMarks are from parent Scene and sub-Scene, respectively.

The relation may also exist at the level of creating different SceneMarks for one Scene. For example, different analytics may be applied to a single Scene, with each of these analytics generating its own SceneMarks. The analytics may also be applied sequentially, or conditionally depending on the result of a prior analysis. Each of these analyses may generate its own SceneMarks. It may be useful to indicate that these SceneMarks are from different analysis of a same Scene.

For example, a potentially suspicious scene based on the simplest motion detection may be created for a house under the Home Security—Vacation SceneMode. A SceneMark may be dispatched immediately as an alarm notification to the end user, while at the same time several time-consuming analyses are begun to recognize the face(s) in the scene, to adjust some of the device states (i.e. zoom in or orientation changes), to identify detected audio signals (alarm? violence? . . . ), to issue cooperation requests to other sensor networks in the neighborhood etc. All of these actions may generate additional SceneMarks, and it may be desirable to record the relation of these different SceneMarks.

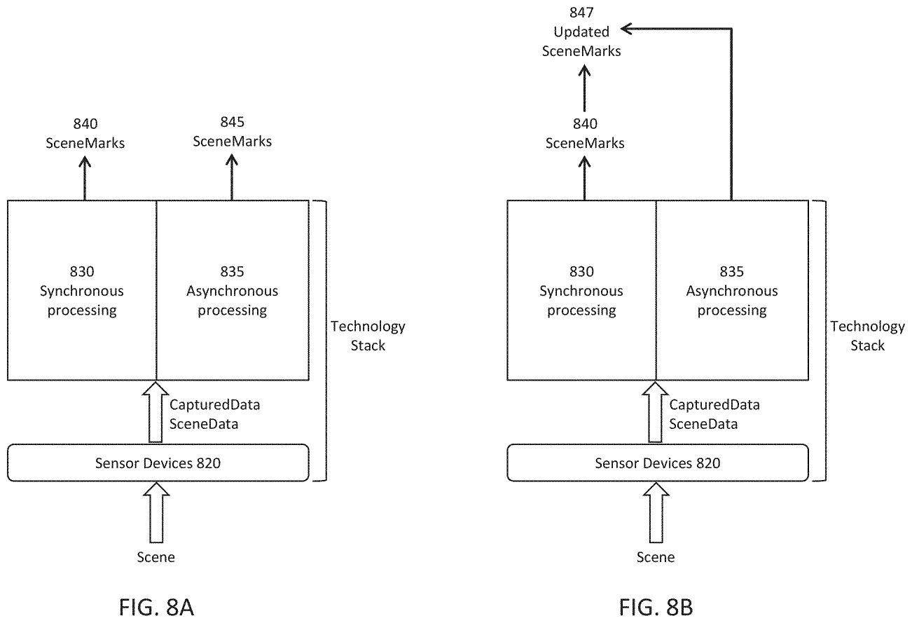

SceneMarks themselves can be processed, separately from the underlying Scene, resulting in the creation of “children” SceneMarks. It may also be desirable to record these relationships. FIGS. 8A and 8B illustrate two different methods for generating related SceneMarks. In this example, the sensor devices 820 provide CapturedData and possibly additional SceneData to the rest of the technology stack. Subsequent processing of the Scene can be divided into classes that will be referred to as synchronous processing 830 and asynchronous processing 835. In synchronous processing 830, when a request for the processing is dispatched, the flow at some point is dependent on receiving the result. Often, synchronous processing 830 is real-time or time-sensitive or time-critical. It may also be referred to as “on-line” processing. In asynchronous processing 835, when a request for the processing is dispatched, the flow continues while the request is being processed. Many threads may proceed asynchronously.

Synchronous functions preferably are performed in real-time as the sensor data is collected. Because of the time requirement, they typically are simpler, lower level functions. Simpler forms of motion detection using moderate resolution frame images can be performed without impacting the frame-rate on a typical mobile phone. Therefore, they may be implemented as synchronous functions. Asynchronous functions may require significant computing power to complete. For example, face recognition typically is implemented as asynchronous. The application may dispatch a request for face recognition using frame #1 and then continue to capture frames. When the face recognition result is returned, say 20 frames later, the application can use that information to add a bounding box in the current frame. It may not be possible to complete these in real-time or it may not be required to do so.

Both types of processing can generate SceneMarks 840, 845. For example, a surveillance camera captures movement in a dark kitchen at midnight. The system may immediately generate a SceneMark based on the synchronous motion detection and issue an alert. The system also captures a useable image of the person and dispatches a face recognition request. The result from this asynchronous request is returned five seconds later and identifies the person as one of the known residents. The request for face recognition included the reference to the original SceneMark as one of its parameters. The system updates the original SceneMark with this information, for example by downgrading the alert level. Alternately, the system may generate a new SceneMark, or simply delete the original SceneMark from the database and close the Scene. Note that this occurs without stalling the capture of new sensor data.

In the example of FIG. 8A, the SceneMarks 840, 845 are generated independently. The synchronous stack 830 generates its SceneMarks 840, often in real-time. The asynchronous stack 835 generates its SceneMarks 845 at a later time. The synchronous stack 830 does not wait for the asynchronous stack 835 to issue a single coordinated SceneMark.

In FIG. 8B, the synchronous stack 830 operates the same and issues its SceneMarks 840 in the same manner as FIG. 8A. However, the asynchronous stack 835 does not issue separate, independent SceneMarks 845. Rather, the asynchronous stack 835 performs its analysis and then updates the SceneMarks 840 from the synchronous stack 830, thus creating modified SceneMarks 847. These may be kept in addition to the original SceneMarks 840 or they may replace the original SceneMarks 840.

In both FIGS. 8A and 8B, the SceneMarks 840 and 845, 847 preferably refer to each other. In FIG. 8A, the reference to SceneMark 840 may be provided to the asynchronous stack 835. The later generated SceneMark 845 may then include a reference to SceneMark 840, and SceneMark 840 may also be modified to reference SceneMark 845. In FIG. 8B, the reference to SceneMark 840 is provided to the asynchronous stack 835, thus allowing it to update 847 the appropriate SceneMark.

From the discussion above, SceneMarks may also be categorized temporally. Some SceneMarks must be produced quickly, preferably in real-time. The full analysis and complete SceneData may not yet be ready, but the timely production of these SceneMarks is more important than waiting for the completion of all desired analysis. By definition, these SceneMarks will be based on less information and analysis than later SceneMarks. These may be described as time-sensitive or time-critical or preliminary or early warning. As time passes, SceneMarks based on the complete analysis of a Scene may be generated as that analysis is completed. These SceneMarks benefit from more sophisticated and complex analysis. Yet a third category of SceneMarks may be generated after the fact or post-hoc. After the initial capture and analysis of a Scene has been fully completed, additional processing or analysis may be ordered. This may occur well after the Scene itself has ended and may be based on archived SceneData.

SceneMarks may also include encryption in order to address privacy, security and integrity issues. Encryption may be applied at various levels and to different fields, depending on the need. Checksums and error correction may also be implemented. The SceneMark may also include fields specifying access and/or security. The underlying SceneData may also be encrypted, and information about this encryption may be included in the SceneMark.

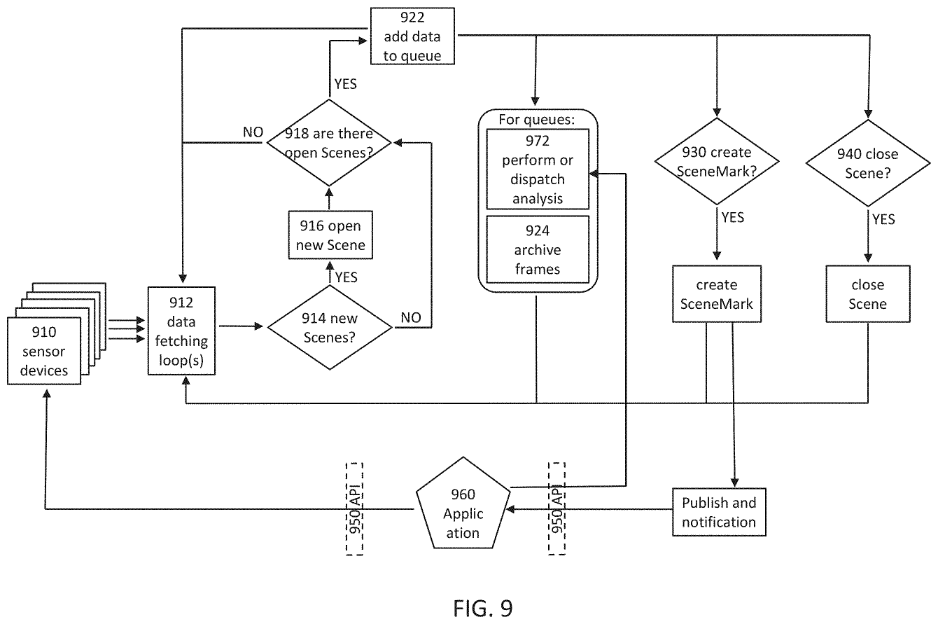

FIG. 9 is a diagram illustrating the overall creation of Scenes, SceneData, and SceneMarks by an application 960. The application 960 provides real-time control of a network of sensor devices 910, either directly or indirectly and preferably via a Scene-based API 950. The application 960 also specifies analysis 970 for the captured data, for example through the use of SceneModes and CaptureModes as described above. In this example, sensor data is captured over time, such as video or an audio stream. Loop(s) 912 capture the sensor data on an on-going basis. The sensor data is processed as it is captured, for example on a frame by frame basis. As described above, the captured data is to be analyzed and organized into Scenes. New data may trigger 914 a new Scene(s). If so, these new Scenes are opened 916. New Scenes may also be triggered by later analysis. For Scenes that are open (i.e., both existing and newly opened) 918, the captured data is added 922 to the queue for that Scene. Data in queues are then analyzed 972 as specified by the application 960. The data is also archived 924. There are also decisions whether to generate 930 a SceneMark and whether to close 940 the Scene. Generated SceneMarks may also be published and/or trigger notifications.

The discussion above primarily describes the initial creation of SceneMarks as marking a Scene of interest or a point of interest within a Scene. However, the SceneMark itself contains useful information and is a useful data object in its own right, in addition to acting as a pointer to interesting Scenes and SceneData. Another aspect of the overall system is the subsequent use and processing of SceneMarks as data objects themselves. The SceneMark can function as a sort of universal datagram for conveying useful information about a Scene across boundaries between different applications and systems. As additional analysis is performed on the Scene, additional information can be added to the SceneMark or related SceneMarks can be spawned. For example, SceneMarks can be collected for a large number of Scenes over a long period of time. These can then be offered as part of a data repository, on which deep analytics may be performed, for example for the data owner's purposes or for a third party who acts under agreement to obtain and analyze the whole or parts of the data content. Since each SceneMark contains relevant information to trace back to the wherewithal of its creation, consistent and large-scale analyses of aggregate SceneMark data spanning multiple service vendors and multiple user accounts becomes possible.

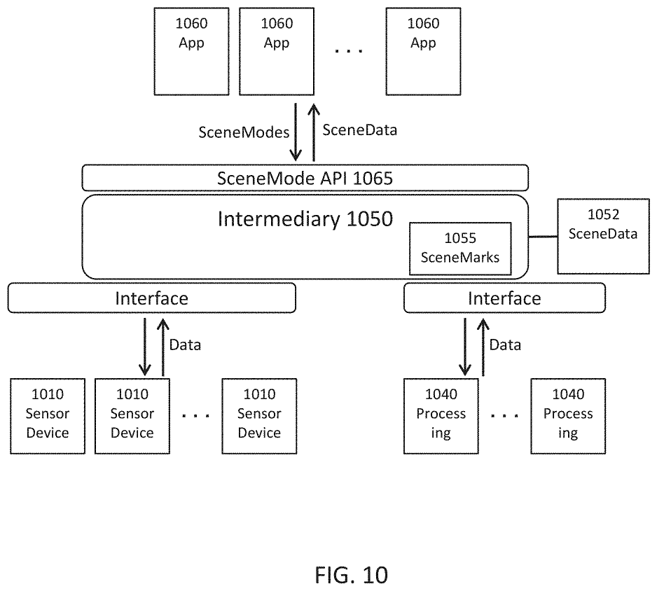

FIG. 10 is a block diagram in which a third party 1050 provides intermediation services between applications 1060 requesting SceneData and sensor networks 1010 capable of capturing the sensor data requested. The overall ecosystem may also include additional processing and analysis capability 1040, for example made available through cloud-based services. In one implementation, the intermediary 1050 is software that communicates with the other components over the Internet. It receives the requests for SceneData from the applications 1060 via a SceneMode API 1065. The requests are defined using SceneModes, so that the applications 1060 can operate at higher levels. The intermediary 1050 fulfills the requests using different sensor devices 1010 and other processing units 1040. The generated SceneData and SceneMarks are returned to the applications 1060. The intermediary 1050 may store copies of the SceneMarks 1055 and the SceneData 1052 (or, more likely, references to the SceneData). Over time, the intermediary 1050 will collect a large amount of SceneMarks 1055, which can then be further filtered, analyzed and modified. This role of the intermediary 1050 will be referred to as a SceneMark manager.

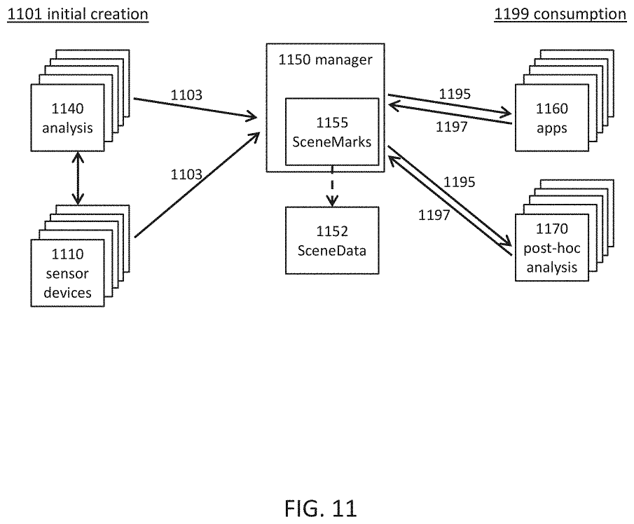

FIG. 11 is a block diagram illustrating a SceneMark manager 1150. In this figure, the left-hand column 1101 represents the capture and generation of SceneData and SceneMarks by sensor networks 1110 and the corresponding technology stacks, which may include various types of analysis 1140. The SceneMarks 1155 are managed and accumulated 1103 by the SceneMark manager 1150. The SceneMark manager may or may not also store the corresponding SceneData. In FIG. 11, SceneData that is included in SceneMarks (e.g., thumbnails, short metadata) is stored by the SceneMark manager 1150 as part of the SceneMark. SceneData 1152 that is referenced by the SceneMark (e.g., raw video) is not stored by the SceneMark manger 1150, but is accessible via the reference in the SceneMark.

The right-hand column 1199 represents different use/consumption 1195 of the SceneMarks 1155. The consumers 1199 include the applications 1160 that originally requested the SceneData. Their consumption 1195 may be real-time (e.g., to produce real-time alarms or notifications) or may be longer term (e.g., trend analysis over time). In FIG. 11, these consumers 1160 receive 1195 the SceneMarks via the SceneMark manager 1150. However, they 1160 could also receive the SceneMarks directly from the producers 1101, with a copy sent to the SceneMark manger 1150. There can also be other consumers 1170 of SceneMarks. Any application that performs post-hoc analysis on a set of SceneMarks may consume 1195 SceneMarks from the SceneMark manager 1150. Of course, privacy, proprietariness, confidentiality and other considerations may limit which consumers 1170 have access to which SceneMarks, and the SceneMark manager 1150 preferably implements this conditional access.

The consumption 1195 of SceneMarks may produce 1197 additional SceneMarks or modify existing SceneMarks. For example, when a high-alarm level SceneMark is generated and notified, the user may check its content and manually reset its level to “benign.” As another example, the SceneMark may be for device control, requesting the user's approval for its software update. The user may respond either YES or NO, an act that implies the status of the SceneMark. This kind of user feedback on the SceneMark may be collected by the cloud stack module working in tandem with the SceneMark creating module to fine-tune the artificial intelligence of the main analysis loop, potentially leading to a autonomous self-adjusting (or improving) algorithm in better servicing the given SceneMode.

Given that the integrity and provenance of the content of SceneMarks preferably is consistently and securely managed across the system, preferably, a set of API calls should be implemented for replacing, updating and deleting SceneMarks by the entity which has the central authority per account. This role typically is a primary role played by the SceneMark manager 1150 or its delegates. Various computing nodes in the entire workflow may then submit requests to the manager 1150 for SceneMark manipulation operations. A suitable method to deal with asynchronous requests from multiple parties would be to use a queue (or a task bin) system. The end user interface receives change instructions from the user and submits these to the SceneMark manager. The change instructions may contain the whole SceneMark objects encoded for the manager, or may contain only the modified part marked by the affected SceneMark's reference. These database modification requests may accumulate serially in a task bin, processed first-in-first-out basis, and as they are incorporated into the database, the revision, if appropriate, should be notified to all subscribing end user apps (via cloud).

The SceneMark manager 1150 preferably organizes the SceneMarks 1155 in a manner that facilitates later consumption. For example, the SceneMark manager may create additional metadata for the SceneMarks (as opposed to metadata for the Scenes that is contained in the SceneMarks), make SceneMarks available for searching, analyze SceneMarks collected from multiple sources, or organize SceneMarks by source, time, geolocation, content or alarm/alert to name a few examples. The SceneMarks collected by the manager also present data mining opportunities. Note that the SceneMark manager 1150 stores SceneMarks rather than the underlying full SceneData. This has many advantages in terms of reducing storage requirements and increasing processing throughput since the actual SceneData not be processed by the SceneMark manager 1150. Rather, the SceneMark 1155 points to the actual SceneData 1152, which is provided by another source.

On the creation side 1170, SceneMark creation may be initiated in a variety of ways by a variety of entities. For example, a sensor device's on-board processor may create a quick SceneMark (or precursor of a SceneMark) based on the preliminary computation on its raw captured data if it detects anything that warrants immediate notification. Subsequent analysis by the rest of the technology stack, on either the raw captured sensor data or subsequently processed SceneData, may create new SceneMarks or modify existing SceneMarks. This may be done in an asynchronous manner. End user applications may inspect and issue deeper analytics on a particular SceneMark, initiating its time-delayed revision or creation of a related SceneMark.

Human review, editing and/or analysis of SceneData can also result in new or modified SceneMarks. This may occur at an off-line location or at a location closer to the capture site. Reviewers may also add supplemental content to SceneMarks, such as commentary or information from other sources. Metadata, such as keywords or tags, can also be added. This could be done post-hoc. For example, the initial SceneData may be completed and then a reviewer (human or machine) might go back through the SceneData to insert or modify SceneMarks.

Third parties, for example the intermediary in FIG. 10, may also initiate or add to SceneMarks. These tasks could be done manually or with software. For example, a surveillance service ordered by a homeowner detects a face in the homeowner's yard after midnight. This generates a SceneMark and generates notification for the event. At the same time, a request for further face analysis is dispatched to a third party security firm. The analysis comes back with an alarming result that notes possible coordinated criminal activity in the neighborhood area. Based on this emergency information, a new or updated SceneMark is generated within the homeowner's service domain and a higher level SceneMark and alert is also created and propagated among interested parties outside the homeowner's scope of service. The latter may also be triggered manually by the end user.

Automated scene finders may be used to create SceneMarks for the beginning of each Scene. The SceneMode typically defines how each data-processing module that works with the data stream from each sensor device determines the beginning and ending of note-worthy Scenes. These typically are based on definitions of composite conditionals that are tailored for the nature of the SceneMode (at the overall service level) and its further narrowed down scope as assigned to each engaged data source device (such as Baby Monitor, Front-door Monitor). Automated or not, the opening and closing of a Scene allows further recognition of a sub-Scene, potentially leading to nested or overlapping Scenes. As discussed above, a SceneMark may identify related Scenes and their relationships, thus automatically establishing genealogical relationships among several SceneMarks in a complex situation.

In addition to the SceneMarks, the SceneMark manager 1150 may also collect additional information about the SceneData. SceneData that it receives may form the basis for creating SceneMarks. The manager may scrutinize the SceneData's content and extract information such as the device which collected the SceneData or device-attributes such as frame rate, CaptureModes, etc. This data may be further used in assessing the confidence level for creating a SceneMark.

On the consumption side 1199, consumption begins with identifying relevant SceneMarks. This could happen in different ways. The SceneMark manager 1150 might provide and/or the applications 1160 might subscribe to push notification services for certain SceneMarks. Alternately, applications 1160 might monitor a manifest file that is updated with new SceneMarks. The SceneMode itself may determine the broad notification policy for certain SceneMarks. The end user may also have the ability to set filtering criteria for notifications, for example by setting the threshold alert level. When the SceneMark manager 1150 receives a new or modified SceneMark, it should also propagate the changes to all subscribers for the type of affected SceneMarks.

For example, in a traffic monitoring application, any motion detected on the streets may be registered into the system as a SceneMark and circulate through the analysis workflow. If these were to be all archived and notified, the volume of data may increase too quickly. However, what might be more important are the SceneMarks that register any notable change in the average flux of the traffic and, therefore, the SceneMode or end user may set filters or thresholds accordingly.

In addition to these differential updates, the system could also provide for the bulk propagation of SceneMarks as set by various temporal criteria, such as “the most recent marks during the past week.” In one approach, applications can use API calls to sub scribe/unsubscribe to various notifications and to devise efficient and consistent methods to present the most recent and synchronized SceneMarks using an effective user interface.

The SceneMark manager 1150 preferably also provides for searching of the SceneMark database 1155. For example, it may be searchable by keywords, tags, content, Scenes, audio, voice, metadata or any of the SceneMark fields. It may also do a meta analysis on the SceneMarks, such as identifying trends. Upon finding an interesting SceneMark, the consumer can access the corresponding SceneData. The SceneMark manager 1150 itself preferably does not store or serve the full SceneData. Rather, the SceneMark manager 1150 stores the SceneMark, which points to the SceneData and its source, which may be retrieved and delivered upon demand.

In one approach, the SceneMark manager 1150 is operated independently from the sensor networks 1110 and the consuming apps. In this way, the SceneMark manager 1150 can aggregate SceneMarks over many sensor networks 1110 and applications 1160. Large amounts of SceneData and the corresponding SceneMarks can be cataloged, tracked and analyzed within the scope of each user's permissions. Subject to privacy and other restrictions, SceneData and SceneMarks can also be aggregated beyond individual users and analyzed in the aggregate. This could be done by third parties, such as higher level data aggregation managers. This metadata can then be made available through various services. Note that although such SceneMark manager 1150 may catalog and analyze large amounts of SceneMarks and SceneData, that SceneData may not be owned by the SceneMark manager (or higher level data aggregators). For example, the underlying SceneData typically will be owned by the data source rather than the SceneMark manager, as will be any supplemental content or content metadata provided by others. Redistribution of this SceneData and SceneMarks may be subject to restrictions placed by the owner, including privacy rules.

FIGS. 10 and 11 describe the SceneMark manager in a situation where a third party intermediary plays that role for many different sensor networks and consuming applications. However, this is not required. The SceneMark manager could just as well be captive to a single entity, or a single sensor network or a single application.

In addition to identifying a Scene of interest and containing summary data about Scenes, SceneMarks can themselves also function as alerts or notifications. For example, motion detection might generate a SceneMark which serves as notice to the end user. The SceneMark may be given a status of Open and continue to generate alerts until either the user takes actions or the cloud-stack module determines to change the status to Closed, indicating that the motion detection event has been adequately resolved.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1. A method implemented on a computer system for specifying and obtaining a higher level understanding of image data, the method comprising:
communicating a SceneMode to a sensor-side technology stack via an application programming interface (API), the sensor-side technology stack comprising a group of one or more sensor devices, wherein:
based on the SceneMode, a workflow that includes analysis of image data captured by the sensor devices is determined and executed by the sensor-side technology stack;
the workflow applies artificial intelligence and/or machine learning to the image data, and detects events based on the image data; and
the workflow generates SceneMarks triggered based on the events detected by the workflow, the SceneMarks comprising messages relating to the triggering events; and
receiving the generated SceneMarks from the sensor-side technology stack via the API.

2. The computer-implemented method of claim 1 wherein the SceneMarks identify the SceneMode.

3. The computer-implemented method of claim 1 wherein the SceneMode does not specify at least some of: the specific sensor devices used in the workflow, the specific sensor-level settings used in the workflow, the specific sensor data captured in the workflow, the specific processing and analysis used in the workflow, and the specific location of the processing and analysis used in the workflow.

4. The computer-implemented method of claim 1 wherein the SceneMode does not specify at least some of the triggering events.

5. The computer-implemented method of claim 1 wherein the artificial intelligence and/or machine learning is cloud-based, and at least some triggering events are detected by the cloud-based artificial intelligence and/or machine learning.

6. The computer-implemented method of claim 1 wherein, based on the SceneMode, the triggering events include at least one of object recognition, recognition of humans, face recognition and emotion recognition.

7. The computer-implemented method of claim 1 wherein multiple applications communicate SceneModes to the sensor-side technology stack via the API, and receive the resulting SceneMarks from the sensor-side technology stack via the API.

8. The computer-implemented method of claim 7 wherein the SceneMarks identify the application communicating the SceneMode.

9. The computer-implemented method of claim 8 further comprising:
storing the SceneMarks from different applications and making the SceneMarks available for subsequent searching and analysis, wherein at least some of the SceneMarks are generating by applying artificial intelligence and/or machine learning to previously stored SceneMarks.

10. The computer-implemented method of claim 1 wherein the API, the SceneMode and a data structure for the SceneMarks are defined in one or more standard(s).

11. The computer-implemented method of claim 10 wherein the standard(s) support SceneMark extensions.

12. The computer-implemented method of claim 1 further comprising:
storing the SceneMarks and making the SceneMarks available for subsequent searching and analysis.

13. The computer-implemented method of claim 1 wherein at least some of the SceneMarks are updated versions of previously generated SceneMarks.

14. The computer-implemented method of claim 1 wherein at least some of the SceneMarks are generating by processing of previously generated SceneMarks.

15. The computer-implemented method of claim 1 wherein the SceneMarks include provenance information that identify sources of the SceneMarks within the workflow.

16. The computer-implemented method of claim 1 wherein the SceneMarks identify types of the triggering events.

17. The computer-implemented method of claim 1 wherein the SceneMarks include alert levels based on the triggering events.

18. The computer-implemented method of claim 1 wherein the SceneMarks include references to the image data on which the triggering events are based.

19. The computer-implemented method of claim 1 wherein the SceneMarks identify relations to other SceneMarks.

20. A non-transitory computer-readable storage medium storing executable computer program instructions for an application to specify and obtain a higher level understanding of image data, the instructions executable by a computer system and causing the computer system to perform a method comprising:
communicating a SceneMode to a sensor-side technology stack via an application programming interface (API), the sensor-side technology stack comprising a group of one or more sensor devices, wherein:
based on the SceneMode, a workflow that includes analysis of image data captured by the sensor devices is determined and executed by the sensor-side technology stack;
the workflow applies artificial intelligence and/or machine learning to the image data, and detects events based on the image data; and
the workflow generates SceneMarks triggered based on the events detected by the workflow, the SceneMarks comprising messages relating to the triggering events; and
receiving the generated SceneMarks from the sensor-side technology stack via the API.
